(19) United States
(12) Patent Application Publication
(10) Pub. No.: US 2009/0078721 A1
(43) Pub. Date: Mar. 26, 2009

(54) Wine dispensing, storing and distribution method and apparatus with recycling feature

(75) Inventors: David E. Hoffman, Landenberg, PA (US); Mark Harris, Landenberg, PA (US)

Correspondence Address: Frank J. Bonini, Jr.;86 The Commons at Valley Forge East, 1288 Valley Forge Road, Post Office Box 750, Valley Forge, PA, 19482-0750, US

(73) Assignee: Paradocx Vineyard LLC

(21) Appl. No.: 11/903,370

(22) Filed: Sep. 21, 2007

(51) Int. Cl. B67D 1/08; B65D 35/56; B67D 5/62

(52) U.S. Cl. 222/1; 222/146.6; 222/105

(57) ABSTRACT

A method and device for facilitating the distribution of wine, including a vessel which is configured with one or more recyclable components which may be configured as a reusable component which, after an initial use, may be prepared for a further use or uses, by one or more steps, such as, for example, cleaning or relabling. The device may be constructed to include a reusable first containment member and a containment element, the first containment member having an interior space which may hold the containment element with a valve connected thereto, the first containment member having an aperture therein so that the valve may pass through the aperture and be accessed from outside the containment member interior space.

### BACKGROUND OF THE INVENTION

1. Field of the Invention

The invention relates to the distribution of wine, and more particularly to methods and apparatus for storing and dispensing wine, including a recycling method and device used for the distribution of wine.

2. Brief Description of the Related Art

Wine has been produced for hundreds of years. Traditionally, wine has been stored in casks, and in smaller quantities, wine today often is sold in glass bottles, which are stoppered with corks, or other material to seal the wine from air entry in order to preserve the wine and prevent spoilage. Wine also has been sold in plastic containers. The plastic containers are generally housed in cardboard boxes.

Wine is sold to consumers in quantities ranging from about 750 ml to four-liter quantities (which is approximately a little over 1 gallon). Large glass bottles often may be used to contain the four-liter or one-gallon size quantities. Even larger size quantities may be sold to restaurants and institutional purchasers. In many instances the average room temperature is higher than the preferred wine serving temperature, the serving temperature being variable depending on the type of wine as well as the personal preferences of the consumers. Some consumers, particularly in the case where white wine is involved, prefer to chill the wine, by refrigerating it. In some cases, a consumer may use a specially designed temperature controlled refrigerator for wine, while in other instances, the consumer simply uses a traditional refrigerator.

Wine bottles often are difficult to store in a refrigerator. Once opened, the wine must be resealed, generally by replacement of the cork or cap. Corks may be formed from natural cork (obtained as the bark of certain trees) or synthetic materials. Where a screw cap or a composite cork top is used (where a cork is attached to a flat plastic disk or the like), the wine generally may be resealed rather easily. However, where a cork is used, upon the initial removal of the cork from the bottle, the cork, or at least a portion of it, will expand, making it difficult to replace into the bottle. Generally, for preservation of the wine, the bottles which are stoppered with the cork, for the most part, are constructed from glass. Therefore, the consumer is faced with the task of forcing an expanded cork into a rigid glass bottle opening. Since removal of the cork is effected using a removal tool, such as a cork screw or other apparatus which releases or withdrawals the cork from the bottle, if the cork is replaced on the bottle for storage, it will generally not be forced into the bottle in its entirety. This makes the bottle and stoppered cork, slightly larger than the original bottle length. In some instances, the larger bottle, with a portion of the cork extending from the top of the bottle, is difficult to store in a traditionally configured refrigerator. Even some consumers who prefer wine to be served at chilled temperatures often, for storage of wine, will store wine (especially wine that has been opened) at a chilled temperature, such as in a refrigerator.

Once wine has been opened, the air exposure tends to oxidize certain components of the wine, which may drastically affect the taste of the wine, in many cases rendering the wine unsuitable or undrinkable. While there have been methods used to eliminate the air from the bottle, such as replacing the air with a pressure of inert gas, and then. restoppering, in some cases, even in spite of these efforts, the wine still undergoes a change, and is prone to spoilage.

Wine bottles are usually made of heavy glass and, once used, must be disposed of. Recycling has become ever important, and remains a concern throughout the world. Recycling of materials, such as glass, plastic and paper products, though saving those resources through reuse, carries with it its own costs and energy utilization, as products which are to be recycled generally must undergo a process which process itself may consume energy. For example, in many cases, the materials which are to be recycled must be transported with a vehicle to a location, and then the materials generally are separated, manually, or using equipment, further increasing the cost and resources used. Recycling may also include breaking down the materials (e.g., melting, pulverizing, etc.) so that the materials may be reused. However, these steps, while preserving the materials for reuse, themselves consume energy. Furthermore, the materials must be formed into further products, again, requiring additional energy to accomplish.

A need exists for an improved container and method for storing and dispensing wine which has improved recycling capabilities.

### SUMMARY OF THE INVENTION

A method and device are provided for facilitating the distribution of wine, including a vessel which is configured with one or more recyclable components. According to one embodiment of the invention, a recyclable component is provided. The recyclable component preferably is configured as a reusable component which, after an initial use, may be prepared for a further use or uses, by one or more steps, such as, for example, cleaning or relabling. According to some embodiments, a label or portion thereof is provided to be reused with the reusable component. According to alternate embodiments, the label is removed, or a new label may be installed over an existing label, or both, removal of a prior label and replacement with a new label is performed.

According to embodiments of the invention, the vessel is configured with a dispenser which facilitates dispensing of the fluid, such as the wine, from the vessel. According to a preferred embodiment, a holding element may be provided and carried within the reusable container portion of the vessel. The holding element may be configured to hold wine, and a dispensing mechanism, such as a regulatable valve, may also be provided.

The vessel, according to preferred embodiments, may be constructed to fit within a refrigerator, such as, for example, a household refrigerator.

Preferred embodiments of the invention include a removable vessel cover or lid which permits access to an interior space of the vessel where the holding element may be contained. The access port of the vessel and removable cover may also facilitate the insertion and holding, of cooling media, such as ice, a cold pack, or the like in the vessel.

A preferred method for distributing a wine product using a recyclable containment apparatus is provided, wherein the device is recyclable by reuse of the containment vessel. The wine distribution may include providing wine in a containment vessel at a point of distribution and receiving a return of the containment vessel or portions thereof (generally after the wine has been removed). The returned vessel may be reconfigured, including refilled with wine. The method may be carried out using the very container returned, without the need to shred or fragment the container and reconstitute it.

According to a preferred embodiment, the vessel may include a removable component which may be replaced, and the vessel may be configured by replacing the removable component so the vessel or reusable portion may be re-distributed with fresh contents.

### BRIEF DESCRIPTION OF THE DRAWING FIGURES

FIG. 1 is a front elevation view of a device for storing and distributing wine according to the invention.

FIG. 2 is a view of the device of FIG. 1, shown with a portion of the wall broken away to expose the containment element.

FIG. 3 is an enlarged view of the encircled phantom line portion of the device as indicated in FIG. 2.

FIG. 4 is a top plan view of the device shown in FIG. 1.

FIG. 5 is a sectional view of the device shown in FIG. 1 taken along the section line 5-5 of FIG. 4, as viewed looking from the left side.

FIG. 6 is a front elevation view of a containment element with the valve illustrated in an exploded perspective view, these components being shown separately from other components of the device.

FIG. 7 is an exploded view of the device of FIG. 1, illustrating the cover, containment element and valve, and the containment member.

FIG. 8 is a schematic illustration of a preferred embodiment of a method of recycling involving storing and dispensing wine using the device illustrated in FIGS. 1-7.

### DETAILED DESCRIPTION OF THE PREFERRED EMBODIMENTS

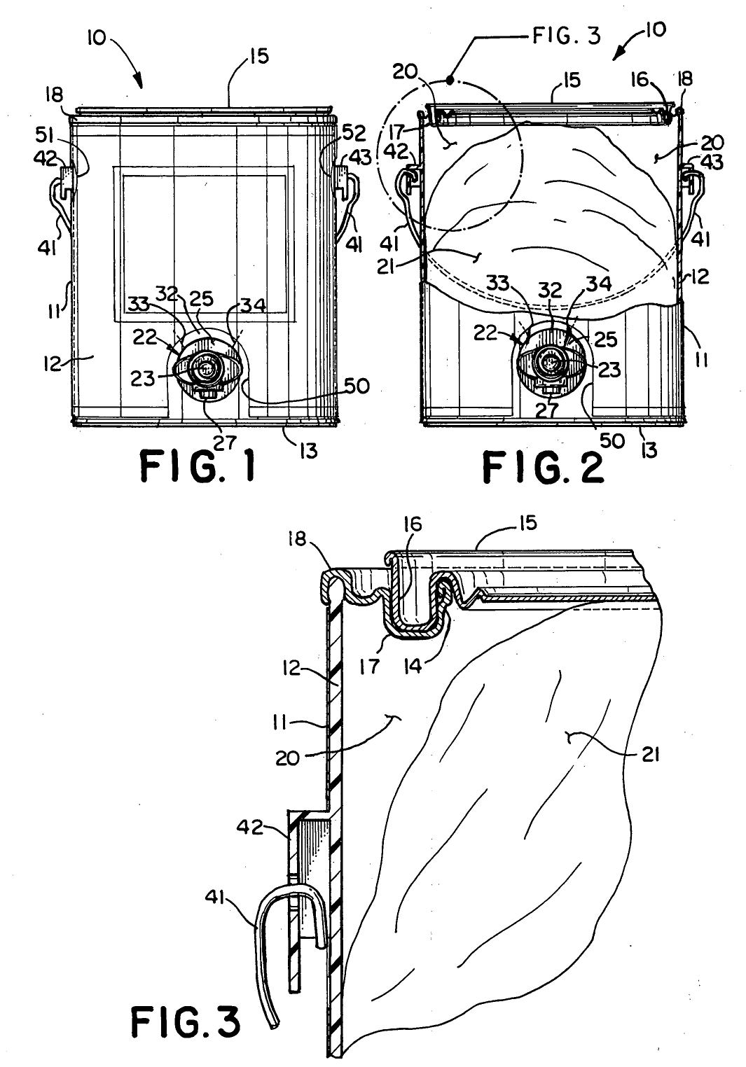

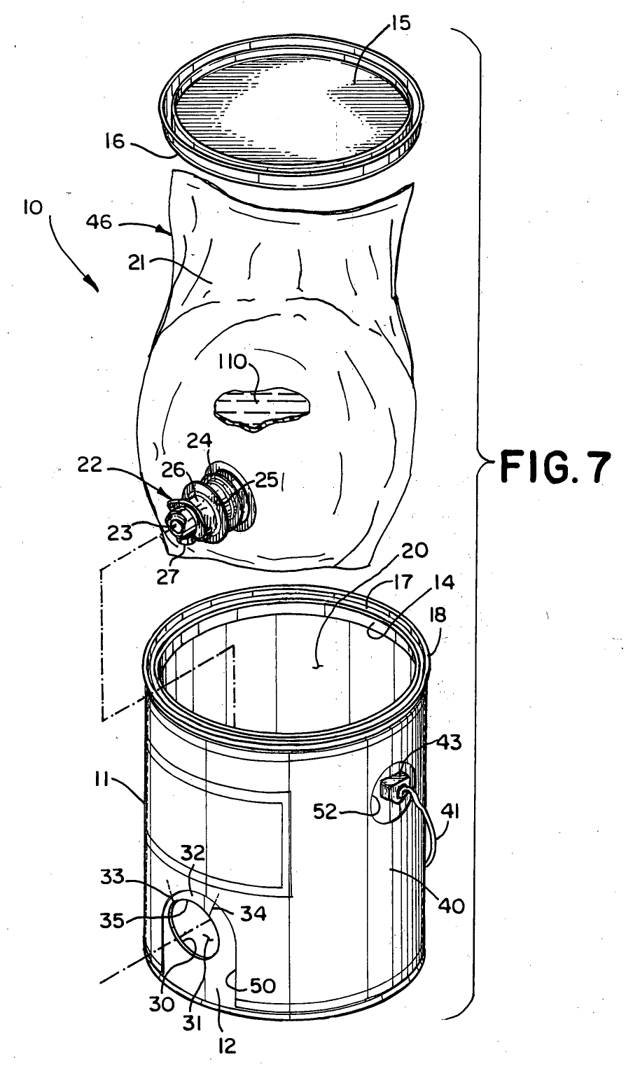

A method and device for facilitating the distribution of consumable fluids, such as wine, is provided. FIG. 1 illustrates a preferred embodiment of a wine storage and distribution device 10 according to the invention. The vessel or device 10 of the embodiment illustrated includes a first containment member 11 having a wall 12, a bottom 13 and an opening therein 14 (FIGS. 3 and 7). A removable cover 15 is shown disposed over the opening 14. The removable cover 15 preferably has attachment means which is illustrated comprising a crimped rim 16 configured to fit within a groove 17 of an annular flange 18 provided on the first containment member 11 (FIG. 3). The cover 15 may be installed on the first containment member 11 to secure contents within the containment member 11. The first containment member 11 preferably is constructed from a rigid material, and more preferably a material which is waterproof. A polyethylene or polypropylene material may be used. Alternately, other suitable materials may be used. According to a preferred embodiment, the first containment member 11 may be molded to provide a floor 19 and circumferential wall 12.

FIG. 2 illustrates a view of the device 10 shown with a portion of the wall 12 and cover 15 broken away. The first containment member 11 has a space therein 20 for accommodating a second containment member, such as the containment element 21. Containment element 21 preferably is constructed from a flexible material which may be sealably attached to one or more valve or tubing components, such as fittings or the like. The containment element 21, for example, may be constructed from polyethylene or nylon, and preferably may have one or more layers, including a barrier layer which minimizes or prevents air from passing through the containment element 21. The containment element 21 may include a multi-layer bag which is commercially available. As shown more particularly in FIGS. 5-8, the containment element 21 communicates with a valve 22. The valve 22 may be any suitable valve useful to regulate dispensing of fluids, such as, wine. The valve 22 may be a commercially available valve that is suitable for dispensing liquid from a bag or containment element 21, and more particularly, where liquid occupies the container volume, and where air (or other gas) is evacuated from the container. The valve 22, illustrated for example, is shown having an actuator 23 which may be depressed to open the valve 22 to permit a flow of fluid, such as wine, from-the containment element 21. A release of the pressure applied to depress the actuator 23 permits the valve 22 to close, thereby stopping the flow.

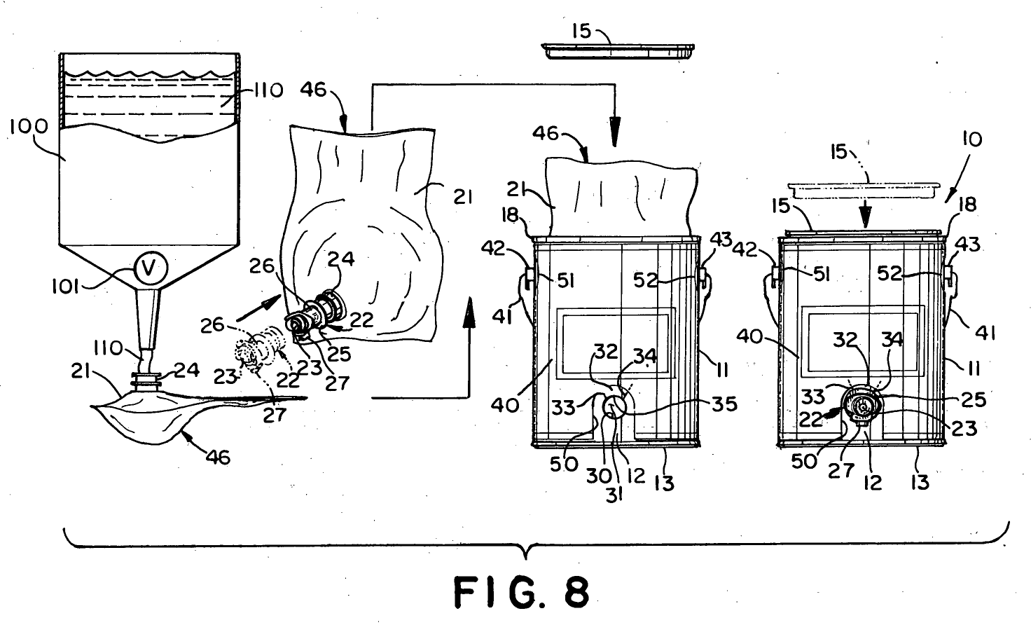

According to a preferred embodiment, the method of configuring the device 10 includes providing wine in the containment element 21. FIG. 8 illustrates an example of steps which may be carried out to configure the device 10 for distribution and sale. A wine dispensing source illustrated, for example, as a vat 100 with a valve 101, may supply the wine 110 that is to be dispensed into the containment element 21. A quantity of wine 110 may be dispensed from the wine vat 100 into the containment element 21. The containment element 21 may be formed from a single sheet, or one or more sheets, of a flexible material, which may be fused together at locations along the edges thereof to form an enclosure as illustrated in FIG. 6. Preferably, the valve 22 is sealingly attached to containment element 21. Referring to FIGS. 5, 6, 7 and 8, a connector 24 is shown as an example of means used to connect the valve 22 with the containment element 21. The connector 24 may be installed on the containment element 21 with an adhesive, by the application of heat or other suitable means. Alternately, the connector 24 may be formed with the containment element 21. In accordance with some embodiments, a friction fit may be used to connect the valve 22 to the connector 24. Alternately, according to other embodiments, the valve 22 may include connection means for direct attachment to the containment element 21.

Referring to FIG. 8, the method may be carried out by filling the containment element 21 with wine and securing the valve 22 to the containment element 21. The valve 22 and containment element 21 may be installed within the first containment member 11. Preferably, the first containment member 11 has a valve opening 31 disposed in the side wall 12. According to a preferred embodiment, the valve opening 31 may be configured with an aperture wall 30, and receiving means may be provided for facilitating receipt of the valve 22 (and according to other embodiments possibly the connector 24 or a portion of the connector 24) therethrough. The receiving means is illustrated in FIG. 2 as biasing means including a flexible tab portion 32 which is formed with the wall 12. The flexible tab portion 32 facilitates maintaining the valve 22 in position on the first containment member 11. The flexible tab portion 32 has a pair of side edges 33, 34, which are angularly disposed. A holding edge 35 is provided at the end of the tab portion 35 which may be used to facilitate holding the valve 22 in position. The tab portion 32 and wall 12 preferably are constructed to facilitate reuse of the first containment member 11. The tab portion 32 may be flexed in an inward direction relative to the interior space 20 when the valve 22 is removed from the first containment member 11 (which may be done as part of configuring the device 10 for reuse).

According to a preferred embodiment, configuring the first containment member 11 for reuse involves removal of the valve 22 and containment element 21 from the device 10. The first containment member 11 may thereafter be configured with another valve 22 and containment element 21 that contains wine thereby permitting its reuse. According to alternate embodiments, the valve 22 may be held by valve holding means, which, for example, may include a mounting flange, nut and threads, bayonet, clip and groove, or other retaining element. The holding means may be used with the flexible tab portion 32.

The insertion of the valve 22 through the aperture 31 may flex the tab portion 32 in a direction away from the wall 12. According to a preferred embodiment, the biasing feature of the tab portion 32 returns the tab portion 32 in a direction toward the wall 12, and may align the tab portion 32 with the wall 12. Optionally, additional means may be employed to further facilitate securing of the valve 22 to the first containment element wall 12, such as, for example, gasketing means, such as a gasket. The valve 22 is illustrated having an actuator or button 23, a flange 25 and a valve dispensing port 27. The aperture wall 30 and tab portion 32 preferably are configured to permit the valve 22 to pass through the opening 31.

The cover 15 may be secured on the first containment member 11. The device 10 with the wine contents contained therein may be distributed. The device 10 also contains content indicia. The content indicia may be provided using a label 40 which may be affixed to the wall 12. The label 40 may be self-adhesive, for example, and may be applied prior to installation of the containment element 21 in the first containment member 11, or may be applied after the containment element 21 has been installed into the first containment member 11.

The method preferably includes a recycling feature which may be carried out using the device 10. The device 10 may be prepared as described herein, with an amount of fluid, such as, for example, wine 110, dispensed therein in the containment element 21. The device 10 includes a transport facilitating means, such as the handle 41 and lugs 42, 43 in which ends of the handle 41 are secured. According to a preferred embodiment, the lugs 42, 43 may be molded with the first containment member 11. Alternately, the lugs 42, 43 may be provided as separate components which are attached to the first containment member 11. Though not shown, the handle 41 may be fitted with a label or even a cushion to facilitate handling. A user or consumer may purchase wine which is contained in the device 10. The device 10 may be placed in a refrigeration apparatus, such as a refrigerator, cooler, ice bath, or the like. For example, the device 10 with the wine 110 contained therein may be stored in a household refrigerator and portions of wine dispensed therefrom, as desired, using the valve 22. Upon depletion of the wine contents from the device 10, the device 10 may be collected (either directly from the consumer, or by returning the device 10 to a designated location). The device 10 directly or indirectly is returned to a processing location where the device 10 may be prepared for reuse and distribution. According to a preferred embodiment, the device 10 may be configured for reuse by removal of the containment element 21. Other elements may also be removed, including the valve member 22, as well as any connector element, such as, for example, the connector 24. According to another embodiment, the consumer may remove and dispose of the containment element 21 and valve 22 prior to returning the first containment element 11 of the device 10. Alternately, the device 10 may be returned, and one or more components, such as the containment element 21 and valve 22, are subsequently removed. The first containment element 21 may be returned with the cover 15, however, according to preferred embodiments, the method of configuring a device 10 may include installing a new cover 15. Optionally, covers 15 may be constructed from a reusable material, such as plastic or metal. In addition, the cover 15 may include an optional coating, such as teflon, paint, or other surface covering to facilitate ease in cleaning, should the cover 15 be recycled for reuse.

Configuring the device 10 for reuse may include installing a current label on the wall 12 of the device 10. The label 40 may be provided in a dimension similar to a previous label 40 so that the label may be placed over a previous label 40. Alternately, a previous label 40 may be removed and a new label 40 installed. The label 40, for example, may have content information as to the product type, variety, volume, and may include date indicia and/or batching or serial number information. According to embodiments of the invention, a unique identifier, such as, for example, a serial number or bar code, may be provided to track the uses of said first containment member 11. The identifier may be provided on the label, or may be separately provided, as an additional label or marking applied to the device 10 (e.g., to the first containment member 11). A bar code may also be provided on the label 40, or may be separately provided on the device 10 directly or using a bar code label. For example, according to one embodiment, a bar code is provided so that the bar code remains visible, or does not require removal from the device 10, even upon installation of a new label 40. This facilitates tracking the number of uses of the device 10, as well as the frequency of uses, should that data be desirable for use.

The device 10 may be configured for reuse by removing the containment element 21 which was previously used to contain wine, and replacing the containment element 21 with a containment element 21 in which wine 110 has been dispensed. According to a preferred embodiment, the replacement containment element 21 is replaced along with the valve 22 and means used for connecting the valve 22 to a containment element 21, such as the connector 24. According to one embodiment, the containment element 21 may be formed or provided having a valve attachment means, such as the connector 24, filled with wine, and then sealed by installing a valve on the connector 24. The device 10 is further configured, as illustrated in FIG. 8, by installing the containment element assembly 45, such as, for example, the containment element 21, valve 22, and valve connector 24. The valve 22 may be inserted through the opening 31 defined by the aperture wall 30, and the containment element 21, containing a volume of wine 110 therein, placed within the first containment member 11. A cover 15 may be installed on the first containment member 11. According to preferred embodiments of the invention, a labeling step is carried out, which includes checking the label contents for content and label correspondence. According to some embodiments, the device 10 may be configured for reuse of the first containment member 11 using the same label where the contents are identical, and where the time frame or other indicia appearing on the label corresponds with the contents. This embodiment may further include placing indicia on the device 10, such as by placing a secondary label (not shown) on the device 10, to correspond with any new labeling, such as a new product date, batch, serial number or the like. The secondary label may be used in conjunction with an original or previous label 40 to function as a new content label for the device 10.

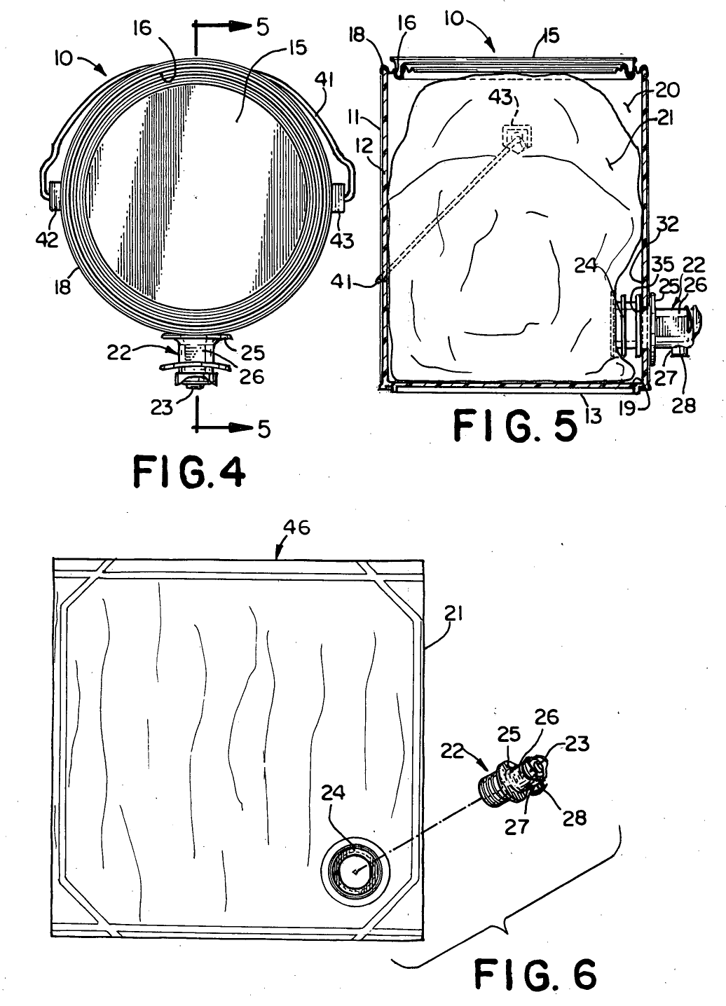

The label 40 may be provided to be affixed to the surface of the containment member 11, and further may be configured to be positioned over the flexible tab portion side edges 33, 34. An indicator means may be provided. The positioning of the label 40 over the tab portion 32 may facilitate a determination of the potential for whether the valve 22 has been replaced after the label 40 has been placed on the device 10. According to the embodiment illustrated in FIGS. 1-7, the label 40 preferably may include an accommodating zone 50 for placement around the location of the valve 22. In addition, the label 40 may include zones or apertures 51, 52 formed therein for accommodating the respective lugs 42, 43 that hold the handle 41. According to this embodiment, the label 40 may be placed over the device 10 either prior to, or after, configuring the device 10 to include a filled containment element 21 in the first containment member space 20 and a valve 22 installed through the opening 31.

The device 10 may be used by operating the actuation button 23 of the valve 22 to dispense quantities of wine 110 from the containment element 21. The device 10 may be configured to include cooling means. The cooling means may be disposed in the interior space 20. For example, the cover 15 may be removed from the opening 14 to permit access to the interior space 20 of the first containment member 11 and the insertion of a cooling media therein. The cooling media may include ice, a cold pack, or the like. According to some embodiments, a sealant or gasket (not shown) may be used to seal the valve 22 and opening 30 against potential leakage from cooling media, such as melted ice, for example, which may be placed into the device 10.

The method may be carried out using the device 10 wherein recycling of the device 10 or components thereof, such as, for example, the first containment member 11, may be accomplished. Consumers may return the device 10 (or any reusable portions thereof) to a collection location, such as, for example a processing location or a purchasing location. The consumer may utilize the return of the device 10 (or, for example, the first containment member 11) to refresh the purchase by purchasing another wine-containing device 10. For example, where the return/collection location is a purchase location, a return of a device 10 may be done while purchasing wine in another device 10.

The method may include means for encouraging recycling. According to one embodiment, a deposit credit system may be utilized to provide a credit for a returned device 10 or reusable portion thereof. For example, according to one preferred embodiment, a deposit credit is given for the return of one or more components of the device 10. For example, a device fee may be charged when the wine is purchased, as a deposit on the device 10, and refinded upon the return of the device 10, or portion thereof, such as the first containment member 11. According to another preferred method, a credit may be given for the return of the first containment device 11. The credit may be given in the form of a cash rebate, a credit toward another purchase, or alternately, may be used to accumulate points in a point value system. For example, a point value system may provide an individual with an identification (or account) wherein points may be allocated for each return of a device 10 or portion thereof. The account may be used to redeem the points for cash or in kind credits for the purchase of wine or even non-wine products, such as merchandise.

According to a preferred embodiment, the device 10 was constructed including a first containment member 11 and was configured with a containment element 21 which contains wine and included a valve 22 connected thereto for dispensing the wine from the containment member 21. According to this example, about 3.0 L of wine was placed into the containment element 21. The containment element 21 was configured to comprise a bag having a volume capacity that may hold a quantity greater than the amount of wine that is to be contained in the containment element 21. The containment space of the containment element 21 may be referred to as a bladder. In this example, the containment element 21 was provided to hold over 3.0 L (the wine volume). The containment element 21 comprised a flexible bag member which was partially-filled with an amount of wine and air evacuated from the remaining space. The filling may be done manually or mechanically, and air may be evacuated using a vacuum means, such as a vacuum pump and fluid line which may be placed into the containment element 21 (or in communication therewith) during or after filling in order to evacuate air. The containment element 21, when filled with the desired quantity of wine 110, was sealed. According to this example, sealing involved installing a valve 22 on the containment member 21, such as for example on the connecting element 24, as shown in the exemplary embodiment of FIG. 8. Alternately, the sealing step may include sealing an opening of the containment element 21 to contain the wine therein. According to an alternate embodiment, the valve 22 may be installed on the containment element 21 before the wine is dispensed into the containment element 21, and the containment element 21 sealed thereafter (for example, through the closing of a seam). In this example, the device 10 containing wine 110 in the containment element 21 was labeled with a label 40 and including the dispensing valve 22 and cover 15 was produced.

Optionally, as shown in FIG. 5, a removable covering, such as, for example, a removable foil 28, may be placed over the valve dispensing port 27 to cover the valve dispensing port 27 from dust or debris, or even air, potentially entering the valve 22. The foil 28 may remain on the valve port 27 and be removed prior to use. In this example, as shown in FIGS. 5, 6 and 8, the containment element 21 and valve 22 are connected via the connector 24. The valve 22 is inserted into the first containment member 11 along with the containment element 21, and the valve actuator 23 and flange 25 are brought through the aperture 31 of the containment member wall 12. The valve 22 has a housing 26 which contains the valve actuator 23 and supports the flange 25. In this example, the housing 26 is positioned in the aperture 31. The containment element 21 is positioned in the interior space 20 and the cover 15 installed. The handle 41 and label 40 may be installed prior to or after the containment element 21 is installed in the first containment member 11. The device 10, now configured and containing wine 110 may be distributed.

According to a preferred embodiment, the containment element 21 is configured having a bladder portion for holding liquids. The bladder portion has a volume capacity V1. A first quantity of wine Vw (the wine volume) may include dispensing the wine quantity Vw into the bladder portion, such that the volume quantity of wine Vw dispensed into the bladder portion is less than the total bladder portion volume V1. According to this preferred embodiment, the remaining volume capacity of the bladder portion Vr (volume remaining) is configured so that air is substantially excluded from that space. Preferably, the bladder portion is manipulable to facilitate installation of the containment element 21 with its contents of wine (the volume of wine Vw) into the first containment member 11 or containment vessel housing. The wine volume Vw may be manipulated into any position within the bladder portion to facilitate installation, as the removal of air provides a bladder having a volume approximating the volume of the wine Vw. The contents (e.g., wine therein) may be shifted within the bladder to facilitate installation of the assembly 45 (see FIG. 8) into the first containment member 11.

A consumer may purchase the device 10 containing the wine. The customary channels through which wine may be purchased, including grocery stores, specialty wine stores, kiosks, outdoor festivals and the like, may be used for distribution and sale of the device 10 containing wine. A consumer may purchase wine in the device 10. The device 10 is constructed so that it may be placed within a household refrigerator. The consumer may dispense wine from the device 10 as needed. When the contents of the device 10 have been exhausted, the device 10 may be returned to a recycling location. The recycling location may be a store, and may include the location from which the wine-containing device 10 was purchased, or another location designated to receive returns of the devices. The returned device 10 may ultimately be delivered to a configuring location where the device 10 is configured for reuse with wine for distribution. The configuring step may include placing a new containment element 21 and valve 22 into a returned first containment member 11. A new cover 15 also may also be installed if a cover 15 is not returned with the used device 10, or, for example, is returned damaged. The device 10 may be relabeled, as needed, and made available for distribution. For example, a winery may serve as a recycling location where used devices 10 are ultimately returned (either directly or from a collection location), refilled with wine and configured for distribution. While discussed in connection with the return of the device 10, according to a preferred embodiment, the return may include the return of a portion of the device 10, such as, for example, the first containment member 11. Where a device 10 is returned with a containment element 21 and valve 22, the containment element 21 and valve 22 are removed from the device 10. The first containment member 11 may undergo a cleaning step, or inspection, as needed.

With the improved wine storage and dispensing device and method, a reduction in energy and resources may be facilitated through the reuse of one or more components. While the invention has been described with reference to specific embodiments, the description is illustrative and is not to be construed as limiting the scope of the invention. For example, according to alternate embodiments of the method, a containment element may be installed fully or partially within the containment member and then filled. A valve may be installed prior to filling of the containment element and the containment element sealed. According to other embodiments, a valve is provided which permits filling the containment element therethrough. Various modifications and changes may occur to those skilled in the art without departing from the spirit and scope of the invention described herein and as defined by the appended claims.

What is claimed is:

1. A method for distributing wine using recyclable means, comprising:
a) providing a first container having at least one wall defining a container interior space, said first container further including at least one opening therein providing access to said interior space, and a closure which is removably installable to cover said opening;
b) providing a containment element assembly including dispensing means for dispensing a fluid therefrom,
c) installing said containment element assembly in said first container by passing said containment element assembly through said at least one first container opening;
d) covering said container opening; and
e) configuring said dispensing means for disposition relative to said first container to be operatively accessible for dispensing fluid from said containment element assembly while said at least one first container opening remains covered.

2. A method for distributing wine using recyclable means, comprising:
a) providing a first container having at least one wall defining a container interior space, said first container further including at least one opening therein providing access to said interior space, and a closure which is removably installable to cover said opening;
b) providing a containment element having at least one opening therein through which a fluid may be introduced thereinto, said containment element being adapted to contain a fluid therein;
c) providing a regulatable valve operatively associated with said containment element to regulate fluid flow from said containment element;
d) configuring said first container by installing said containment element within said first container interior space and installing said associated regulatable valve to protrude outwardly from said first container wall;
e) delivering an amount of fluid into said containment element;
f) dispensing fluid from said containment element;
g) removing said containment element and associated valve from said first container; and
h) repeating at least steps b through e.

3. The method of claim 2, wherein repeating at least steps b through e is accomplished wherein step b of the repeated steps comprises using a containment element which was not used in the previous series of steps b through e.

4. The method of claim 2, wherein repeating at least steps b through e is accomplished wherein step b of the repeated steps comprises using a containment element which was not used in the previous series of steps b through e, and wherein step c of the repeated steps comprises using a valve which was not used in the previous series of steps b through e.

5. The method of claim 2, wherein the step of removing said containment element from said first container includes removing said closure to expose said first container opening, and removing said containment element from said first container through said first container opening.

6. A method of recycling a containment vessel for wine, wherein said wine is stored, sold and distributed from said containment vessel, and wherein said containment vessel is recycled for reuse, the method comprising:
a) providing a containment vessel containing wine to a recipient including providing a first amount of wine in said containment vessel;
b) receiving said containment vessel for recycling after wine in said containment vessel has been dispensed;
c) preparing the containment vessel for receipt of a second amount of wine;
d) providing another amount of wine in said containment vessel; and
e) distributing said containment vessel with said another amount of wine.

7. The method of claim 6, including repeating steps b though e one or more times.

8. The method of claim 6, wherein providing a containment vessel containing wine includes configuring a containment vessel by providing wine in a containment element fashioned with a bladder portion to hold fluid therein and enclosing the wine therein using a regulatable valve in sealing communication with the bladder portion of said containment element;
wherein said containment vessel includes a housing portion having at least one wall and an opening therein for receipt of said containment element and further includes a removable cover configured for placement on said containment vessel to cover said opening and removal therefrom to expose said opening;
wherein configuring the containment vessel includes installing said containment element bladder portion in said containment vessel housing portion by inserting said containment element bladder portion into said housing and positioning said regulatable valve in a location accessible from outside of said containment vessel housing by inserting said valve through an aperture disposed in said housing wall,
wherein inserting said valve through said aperture includes:
(i) engaging a biasing member with said valve and moving said biasing member away from said wall to form with said aperture an opening larger than said aperture,
(ii) inserting said valve through said opening larger than said aperture, said valve having a flange which is passed through said opening larger than said aperture to clear the biasing member, wherein clearing the biasing member releases the biasing member which is biased to return toward said wall; and
wherein said bladder portion has a volume capacity V1 and wherein providing a first quantity of wine Vw includes dispensing said quantity of wine Vw into said bladder portion, wherein the volume quantity of wine Vw is less than said bladder portion volume V1 and wherein the remaining volume capacity of said bladder portion Vr is configured to substantially exclude air, and wherein said bladder portion is manipulable to facilitate installation of the containment element with the volume of wine Vw therein into the containment vessel housing.

9. The method of claim 8, wherein said containment vessel housing is reused in the form said housing portion was previously used by configuring the containment vessel with another containment element and valve.

10. The method of claim 9, wherein said bladder portion is comprised of a recyclable material.

11. The method of claim 9, wherein said housing portion is comprised of recyclable material such that when said housing portion is no longer in use, it may be recycled for use in other products.

12. A device for storing and distributing a consumable fluid product comprising:
a) a first containment member having at least one wall defining an interior space;
b) an aperture provided in said container wall;
c) a containment element for carrying said consumable fluid product therein; and
d) a regulatable dispensing valve sealingly in communication with said containment element and connected thereto.

13. The device of claim 12, wherein said first containment member is configured for reuse.

14. The device of claim 13, wherein said valve includes at least a portion which is configured to pass through said aperture.

15. The device of claim 14, wherein said containment element and said regulatable dispensing valve are removably mounted to said first containment member, and wherein said first containment member is adapted to receive a replacement containment element and valve upon the removal of a previously mounted containment element and valve.

16. The device of claim 12, including
a connecting member which connects said containment element with said valve;
wherein said connecting element is disposed within said containment member interior space, and wherein said valve has a portion which is received within said aperture and which connects with said containment element in said containment member interior space.

17. The device of claim 12,
wherein said first containment member has an opening therein, is configured for reuse and is constructed from a waterproof material, and
wherein the device includes a removable cover, said cover being configured to cover an opening of said first containment member to regulate access to said containment member interior space;
wherein said aperture is defined in part by biasing means for biasing said valve relative to its installation on said first containment member, wherein said biasing means comprises at least one tab portion which is formed in said first containment member wall and is flexibly provided for movement relative to said containment member wall, said tab portion having a pair of angular edges and a holding portion;
wherein said containment element and said regulatable dispensing valve connected thereto are adapted for removal from said first containment member;
wherein the device further includes:
a handle connected to said first containment member and being swingably disposed for movement between an upright position for carrying and a lowered position for facilitating storage of said device;
a label containing indicia corresponding with contents of said containment element, said label being configured with at least one accommodation zone for accommodating the location of the aperture and valve passing therethrough; and
a unique identifier provided to track the uses of said first containment member.

18. A method of distributing wine using a recyclable feature including recycling a containment vessel for wine, wherein said wine is stored, sold and distributed from said containment vessel, and wherein said containment vessel is recycled for reuse, the method comprising:
a) providing a containment vessel containing wine to a recipient including providing a first amount of wine in said containment vessel, said containment vessel including at least one reusable portion and having a label thereon identifying said wine and including a unique identifier for identifying the containment vessel;
b) receiving at least said containment vessel reusable portion for recycling after wine in said containment vessel has been dispensed;
c) preparing the containment vessel for receipt of a second amount of wine;
d) providing a second amount of wine in said containment vessel;
e) maintaining a database containing information pertaining to the unique identifier and the containment vessel, including the number of uses of said containment vessel; and
f) distributing said containment vessel with said second amount of wine.

19. The method of claim 6, wherein the containment vessel includes at least one reusable portion, and the method includes allocating a credit for the return of said containment vessel reusable portion.

20. The method of claim 16, wherein the containment vessel portion returned for credit is reused for the distribution of wine.

21. The device of claim 12, wherein said first containment member interior space comprises means for accommodating cooling media therein.
